(19) United States
(12) Patent Application Publication
(10) Pub. No.: US 2014/0313312 A1
(43) Pub. Date: Oct. 23, 2014

(54) DIGITAL MICROSCOPE AND METHOD FOR OPTIMIZING THE WORK PROCESS IN A DIGITAL MICROSCOPE

(71) Applicant: Carl Zeiss Microscopy GmbH, Jena (DE)

(72) Inventors: Alexander GAIDUK, Jena (DE); Dominik Stehr, Jena (DE); Benno Radt, Jena (DE); Wolf Jockusch, Gottingen (DE); Enrico Geissler, Jena (DE); Johannes Winterot, Jena (DE); Markus Gnauck, Jena (DE); Johannes Knoblich, Jena (DE); Max Funck, Weimar (DE)

(73) Assignee: Carl Zeiss Microscopy GmbH, Jena (DE)

(21) Appl. No.: 14/255,914

(22) Filed: Apr. 17, 2014

(30) Foreign Application Priority Data
Apr. 19, 2013 (DE) 10 2013 006 994.7

(51) Int. Cl. H04N 5/232; G02B 21/36

(52) U.S. Cl. CPC H04N 5/23209; G02B 21/365
USPC 348/79

(57) ABSTRACT

The invention relates to a digital microscope and to a method for optimizing a work process in such a digital microscope. The digital microscope comprises according to the invention at least one first monitoring sensor for observing a sample (08), a sample table (4), an optics unit (02) or a user, and a monitoring unit. In the method according to the invention, first operating data of the first operating sensor are acquired and analyzed and evaluated in an automated manner in the monitoring unit, in order to generate control data and to use said data for controlling the work process of the digital microscope.

The invention relates to a digital microscope and to a method for optimizing the work process in a digital microscope, in particular for use in material microscopy and for applications in quality control.

In microscopy, macro photographs of a sample are frequently taken for documentation purposes with a separate camera or with low resolution. In biomedical microscopy applications, an overview image or overall image can be generated by joining together (stitching) numerous microscopic images. In the computer representation of geographic maps, an overview image is also commonly used in order to provide additional information to the user.

From WO 1998/044446 A1 a system and a method are known for image representation in a computer-controlled microscope. Here, a macro image with low resolution is first generated from individual tiles. Using the selected region of this macro image, the sample table is moved to predefined sites, in order to generate the corresponding high-resolution image as a tile of the overall image.

US 2006 0092505 A1 discloses a continuous zoom system and methods using several optical pathways and digital zoom techniques.

From JP 7015721 A, a microscope system is known which comprises an overall image camera and a microscope camera. Using a switch it is possible to switch between the adjacently arranged cameras; the sample is positioned accordingly in an automated manner under the respective selective camera.

U.S. RE 34622 E1 describes a microscopic display system in which the image is divided into two optical pathways having different levels of resolution, recorded by two different cameras, and represented on a respective monitor.

When examining samples using a microscope, the user usually first has to check visually whether the sample is positioned correctly under the lens and must estimate, for example, the distance between the sample and the lens, in order to avoid a collision between the sample and the lens during the investigation. This preliminary check is time consuming for the user and, in spite of careful work, it cannot always reliably prevent the destruction of the optics or the sample.

The problem of the invention is to provide an improved digital microscope and a method which make it possible to simplify and substantially automate the work process during microscope work.

The problem is solved by a digital microscope having the features of claim 1 and by a method having the features of claim 7.

The digital microscope according to the invention comprises first, in a known way, an optics unit and a digital image processing unit (optical engine) which are arranged on a preferably swivelable microscope body. A microscope image sensor is used for capturing an image of a sample which is positioned on the sample table for examination. The functions of the optics unit and image capture are known to the person skilled in the art, and therefore these details are not discussed further.

According to the invention, the digital microscope comprises at least one first monitoring sensor whose monitoring data are used for controlling the various functions of the work process during microscopy work. Moreover, it comprises a monitoring unit for the automated evaluation of the data of the monitoring sensor. The control of the work process comprises essentially software functions.

The first monitoring sensor is used primarily to observe the sample, preferably for taking a two-dimensional overview image of the sample. On the basis of this overview image it is possible, for example, to check in an automated manner whether the sample has been positioned correctly on the sample table. For positioning the sample, it is possible to move in the X and Y direction, by reference to the overview image of the stage, until the desired position has been reached.

This is the case, for example, if the overview image is aligned at least in some sections with the microscopic image of the first image sensor. Known image manipulation processes offer such functionalities.

Moreover, the overview image is the basis for navigating “on” the sample during the microscopy work, which means that by “pointing” to areas in the overview image and selecting a desired magnification, the sample table can be moved in an automated manner and the optics unit can be adjusted in an automated manner depending on the selection.

The overview image can be used as a live image, particularly for aligning and positioning the sample. By means of a snapshot function, the snapshot of certain situations during microscopy work is possible with the best resolution. In addition, a combination of live image and snapshot that combines the automation function of the live image with the improved resolution of the snapshot is possible.

It is also possible to carry out the capturing of the overview image and the capturing of the microscope image simultaneously or subsequently or alternatingly.

The advantages of the invention are in particular that the automated work process during microscopy work and the operation of the microscope can be simplified considerably in an easy and effective way.

The method according to the invention is used for optimizing the work process in a digital microscope, which comprises an optics unit, a digital image processing unit, and at least one first monitoring sensor. First, during the observation of a sample arranged on the sample table or during the observation of the sample table or during the observation of the optics unit or during the observation of a user, first observation data of the first monitoring sensor are acquired.

These first observation data are analyzed and evaluated in an automated manner, and control data are generated therefrom.

The control data are used for controlling various components, that is to say for controlling the work process of the digital microscope.

In a particularly preferred embodiment, the first observation data are a two-dimensional overview image, which is used as already described above.

In a preferred embodiment of the invention, the digital microscope comprises a second monitoring sensor and/or additional monitoring sensors. Here, the individual monitoring sensors are implemented in a preferred embodiment as image sensors or cameras and arranged at different spatial sites in the digital microscope. Here it is advantageously possible to process the data of the first and of the second monitoring sensor in the monitoring unit into three-dimensional overview information.

Alternatively, a three-dimensional image can be calculated by means of software from data of the first monitoring sensor with different positions of the sample table or different focal lengths.

The three-dimensional overview information can be used for a evaluating a Z topology, that is for height information of the sample. This information in turn is used advantageously to support autofocusing functions of the digital microscope and/or to establish an approximate three-dimensional overview image.

When a third monitoring sensor is used, a collision control can be implemented additionally in a simple manner. This collision control can be active in the case of movement of the sample table or movement of the optics unit and can interrupt the respective process if there is a risk of collision.

This third monitoring sensor or additional monitoring sensors can also be capacitive sensors, resistive sensors, ultrasound sensors, infrared sensors or other suitable sensors, instead of image sensors.

For example, a contact sensor could detect the contact with the sample table during its movement or during the movement of the optics unit, and if necessary the corresponding movement could be stopped if there is a risk of collision. The person skilled in the art will recognize possible variants and adapt the respective required configuration and sensor selection accordingly.

Naturally, the combination of different monitoring sensors for all possible work process simplifications is conceivable and covered by this invention.

The first monitoring sensor and optionally additional monitoring sensors can be designed differently and incorporated in the work process. Here, in the case of several sensors, it is not necessary that they all have the same configuration and design.

If image sensors, or cameras, are used as monitoring sensors, they can
each comprise an image processing processor “of their own”,
provide observation data (image information) for a further processing in the main media processor,
provide observation data (image information) for further processing in a digital programmable logic (Main-FPGA) of the digital microscope, or
evaluate observation data (image information) in a FPGA “of their own.”

Another advantageous embodiment of a digital microscope moreover comprises an auxiliary illumination device.

The latter can be a separate illumination device which produces a continuous illumination, for example, by LED or OLED.

However, it is also possible to use a flash light which, advantageously, allows an energy-saving illumination of a large area—synchronized with the image taking.

An additional alternative or variant for the auxiliary illumination device is a structured illumination, for example, a laser-or LED-row projection or a pattern projection that is adapted especially to the sample, the application, the microscope contrast or additional features. This can be helpful for generating 3D-profile information of the sample and for distance determinations relative to certain areas.

Similarly, it is possible to illuminate in different sequences for different measurement problems; for example, by means of travel time determinations, the distance relative to a sample or to or a distance map of a region can be determined very precisely.

All the above-mentioned options and variations can be adapted to the required measurement problems and microscope configurations.

The function of the monitoring sensor is incorporated efficiently in the automated work process of the digital microscope. Depending on a special individual configuration, different levels of integration in the hardware and software of the digital microscope are required. For example, if a repositioning or a sequentially changed position of the sample is required for generating the overview image or the microscope image, the movement of the sample table must be incorporated accordingly in the control device of the digital microscope.

Below, as examples, two possible work processes are mentioned, which can be carried out with a digital microscope according to the invention.
Work process 1: “Start and setting of the smallest field of view”
Work process 2: “Search for another microscopic field of view in the same microscopic preview”

Another work process for generating an image in another area comprises the basic steps
Selecting another center in the overview image
Repositioning the sample
Image taking

This example represented in Table 1 shows a possible sequence of steps in a work process from switching on the digital microscope to the image taking All user actions and automated actions of the digital microscope are indicated.

TABLE 1

| Implementation step | Internal step (control data) | Details |
|---|---|---|
| Alignment of the | Setting the highest Z position | |
| components | of the optics unit | |
| | Setting the lowest z position | |
| | of the sample table | |
| | Distance between optics unit | |
| | and sample table is 245 mm | |
| | Moving the sample table in | for a 130 × 100 mm sample |
| | XY position for the overview | table: |
| | | X = 65 mm, Y = 0 mm |
| | | for a 150 × 100 mm sample |
| | | table: |
| | | X = 75 mm, Y = 0 mm |
| Start live | Illuminating the overview | Overview illumination ON |
| overview | region | Main sensor illumination OFF |
| | Trimming the overview image | Visible area at a distance of |
| | to 130 × 100 mm | 245 mm: 260 × 200 mm |
| | | Samples representable up to a |
| | | height of 125 mm. |
| | Representing the overview | Minimum reasonable |
| | image in the live mode | resolution of the sensor (for |
| | | maximum speed) |
| Placement of | Positioning the sample on the | |
| sample | sample table | |
| | Aligning the sample using the | |
| | live overview image | |
| Taking the | Switching to maximum | 8 MP@1.5 fps “still image |
| overview image | resolution of the image sensor | mode” |
| | Option 1: | Option A: |
| | Manual focusing of the image | Taking image stack by focus |
| | sensor | variation |
| | | Generating EDoF (Extended |
| | | Depth of Field) image |
| | | Option B: |
| | | Taking image stack by |
| | | displacing the optics unit |
| | | Generating EDoF image. |
| | | Option C: |
| | | Different overview images for |
| | | different XY positions of the |
| | | stage for stereogrammetry. |
| | | reduced DoF |
| | | Option D: |
| | | Manual setting of the focus by |
| | | operator and taking of the |
| | | overview image |
| | | Option E: |
| | | Focusing of the image sensor |
| | | approximately 20 mm above |
| | | the object plane. (=225 mm |
| | | from optics unit) |
| | Option 2: | Option A: |
| | AF (auto focus) of the image | use standard AF algorithm of |
| | sensor | the image sensor in predefined |
| | | areas. |
| | | AF and image taking. |
| | | Option B: |
| | | User interaction with live |
| | | overview image for the |
| | | selection of a POI (Point Of |
| | | Interest) AF on POI and image |
| | | taking |
| | User selection between | |
| | individual image and EDoF | |
| | Distortion correction of the | Option A: |
| | overview image | internal correction option of |
| | | the image sensor (for example, |
| | | SONY) |
| | | Option B: |
| | | Use of a special model (simple |
| | | openCV algorithm by |
| | | Amplify) |
| | | Option C: |
| | | Use known Zeiss correction |
| | | algorithm |
| | Transferring the overview | |
| | image to the GUI | |
| Determine coordinate | Option 1: | |
| system | user defined | |
| | Option 2: relative to the stage | |
| Microscope view | Switch on illumination for | Overview illumination OFF |
| | main sensor | Main sensor illumination ON |
| | | 0.5x: ring light 100% |
| | | 1.6x: ring light 50% |
| | | 5x: bright field 20% |
| | Moving the sample table for | Center point of the overview |
| | alignment with the optical axis | image superimposed over |
| | of the optics unit | center point of the |
| | | microscopic view |
| | | for 130 × 100 mm sample |
| | | table: |
| | | X = 65 mm, Y = 50 mm |
| | | for 150 × 100 sample table: |
| | | X = 75 mm, Y = 50 mm |
| | Moving the sample table in | To the pivot point |
| | the Z direction (vertically) | In any Z position for focusing |
| | | Lowest z position |
| | | 0.5x: to the pivot point |
| | | 1.6x: to the pivot point |
| | | 5x: to the pivot point |
| | Digital zooming in on the | Overview image surface area: |
| | overview image for | microscope image surface |
| | establishing the correct | area = 1:3 |
| | relation between the | |
| | represented images | |
| Focus | Option 1: OP | Coarse software AF with |
| | (object plane), AF (autofocus) | lowest magnification and |
| | | lowest aperture opening |
| | | Coarse software AF with |
| | | lowest magnification and |
| | | largest aperture opening |
| | | Fine software AF with largest |
| | | aperture opening |
| | Option 2: OP manual + AF | Live overview |
| | with software | Coarse focus with microscopic |
| | | image |
| | | Fine software AF with largest |
| | | aperture opening |
| | Option 3: OP AF in OP | Coarse hardware AF with |
| | hardware | lowest magnification and |
| | | lowest aperture opening |
| | | Coarse hardware AF with |
| | | lowest magnification and |
| | | largest aperture opening |
| | | Fine hardware AF with largest |
| | | aperture opening |
| | Option 4: OP manual by user + | Manual movement OP for |
| | AF in software | bringing the sample closer to |
| | | AF |
| | | Fine software AF with |
| | | aperture in accordance with |
| | | the zoom setting |
| Finding the pivot | If the focusing has been | Moving of OP and sample |
| point plane | achieved, the sample can be | table by the same distance in |
| | moved to the swivel plane | the direction of the swivel |
| | | plane |

Several preferred embodiments of the invention are described below in reference to the figures.

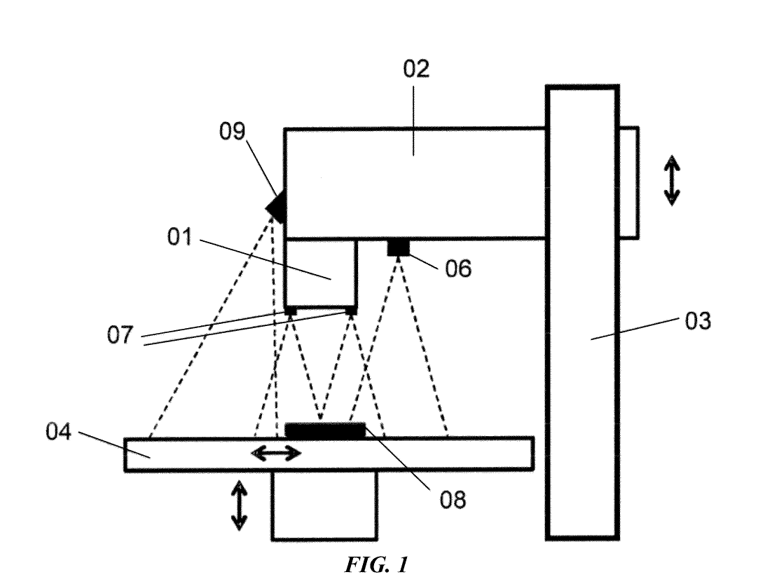

FIG. 1 shows: a diagrammatic representation of a preferred arrangement of several monitoring sensors in a digital microscope;

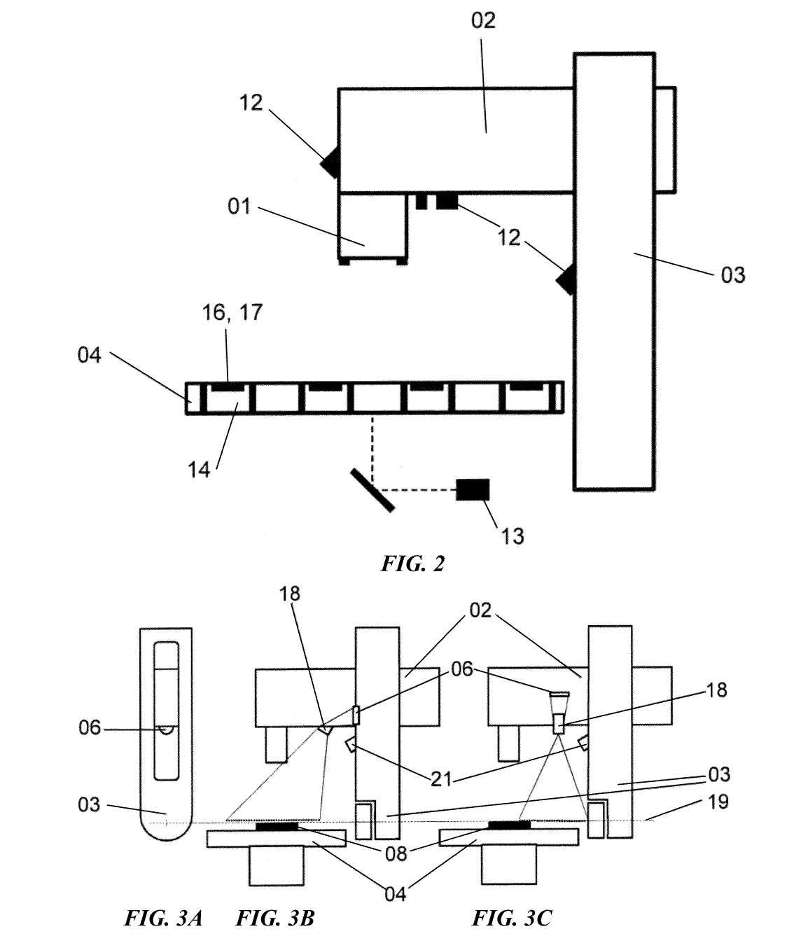

FIG. 2 shows: a diagrammatic representation of a digital microscope with different monitoring sensors;

FIG. 3 shows: a representation of positioning possibilities of a first monitoring sensor in a digital microscope;

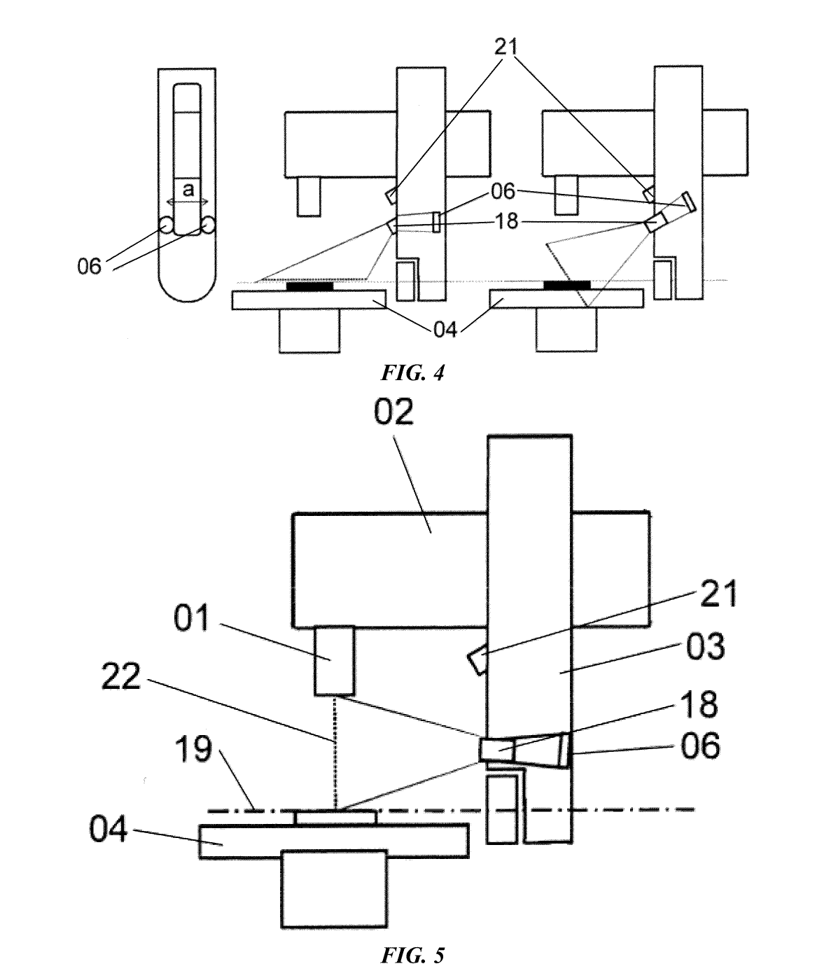

FIG. 4 shows: a representation of positioning possibilities of a first and of a second monitoring sensor, as well as an auxiliary illumination device in a digital microscope;

FIG. 5 shows: an additional diagrammatic representation of a positioning possibility of a monitoring sensor;

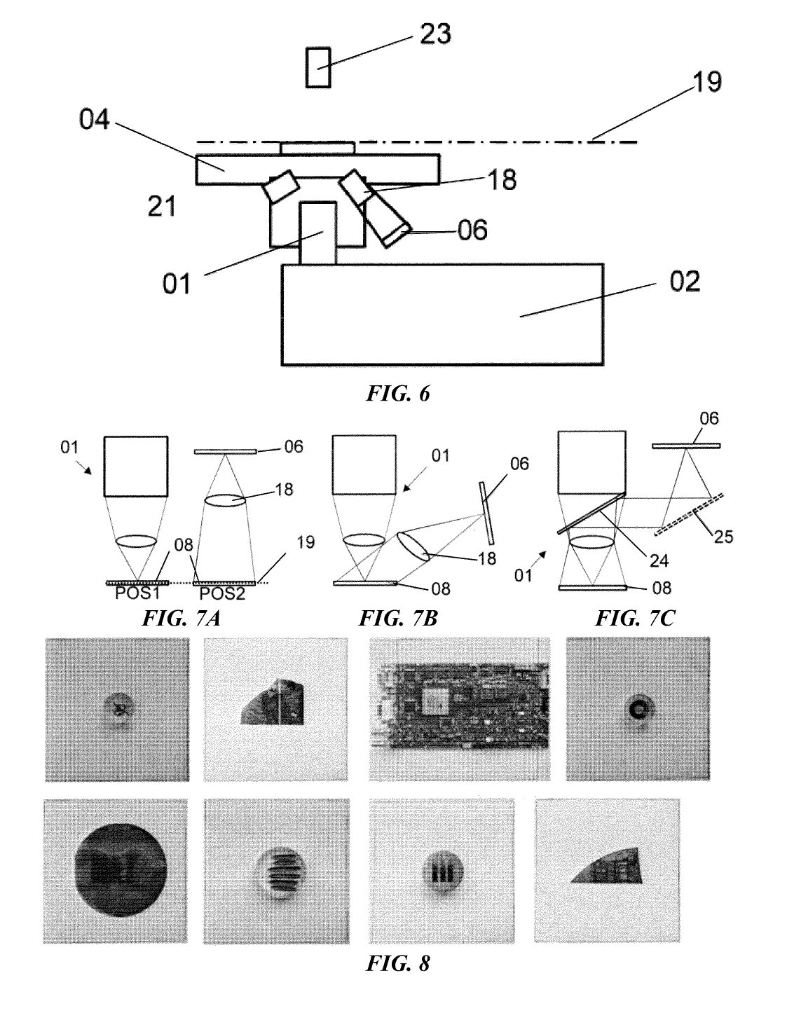

FIG. 6 shows: a representation of positioning possibilities of a first monitoring sensor in an inverted digital microscope;

FIG. 7 shows: a diagrammatic representation of optical pathways in the case of a different arrangement of a first monitoring sensor in a digital microscope;

FIG. 8 shows: a collection of different overview images;

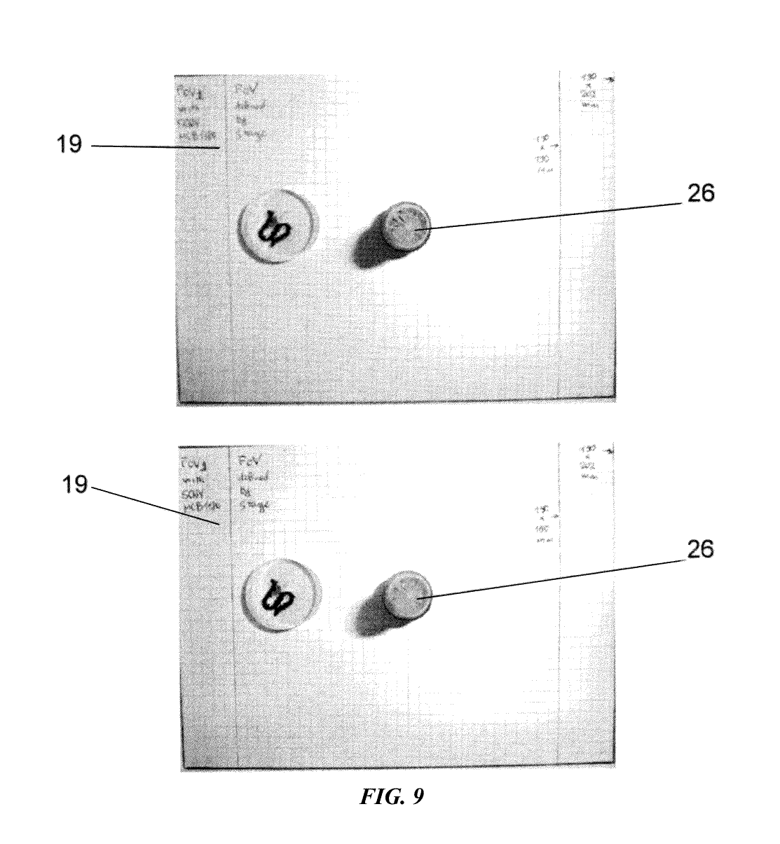

FIG. 9 shows: different overview images with different depths of field;

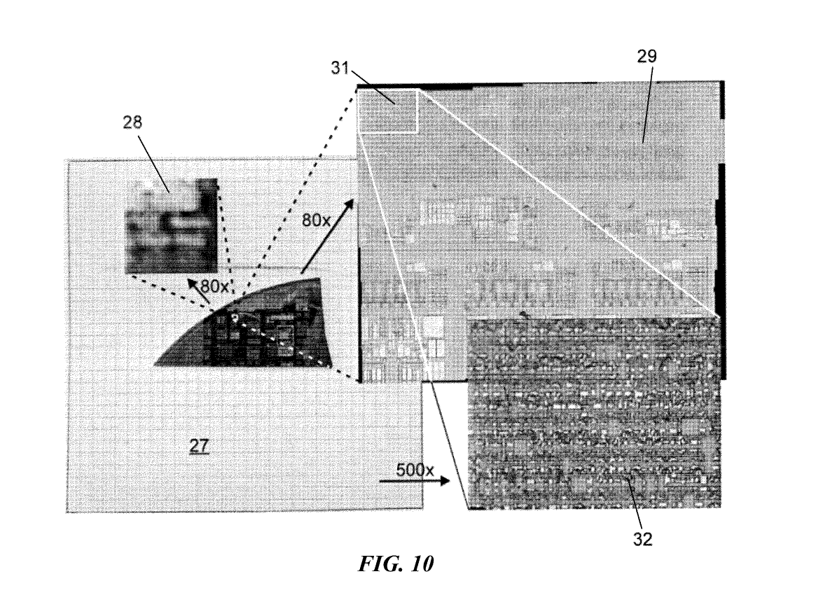

FIG. 10 shows: a work process represented as an example in a digital microscope according to the invention;

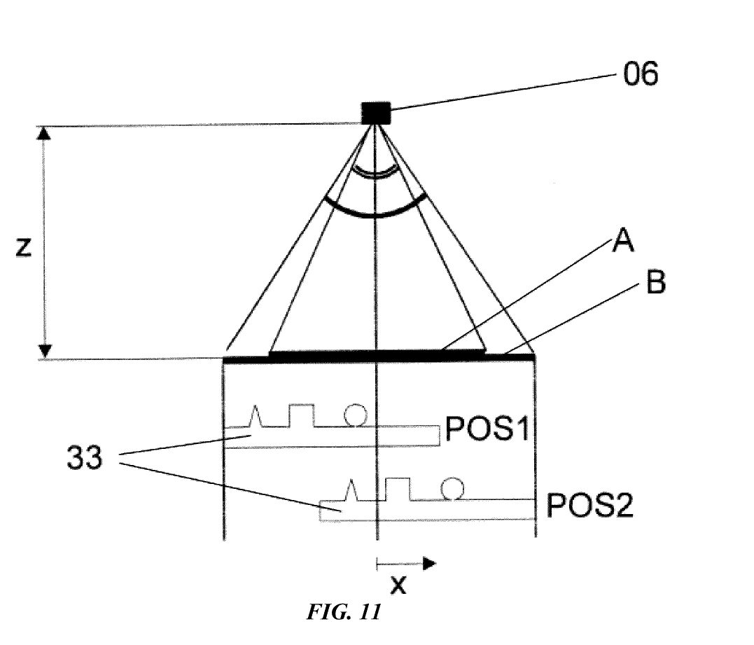

FIG. 11 shows: a preferred embodiment of a digital microscope, wherein a three-dimensional overview image is generated with a first monitoring sensor;

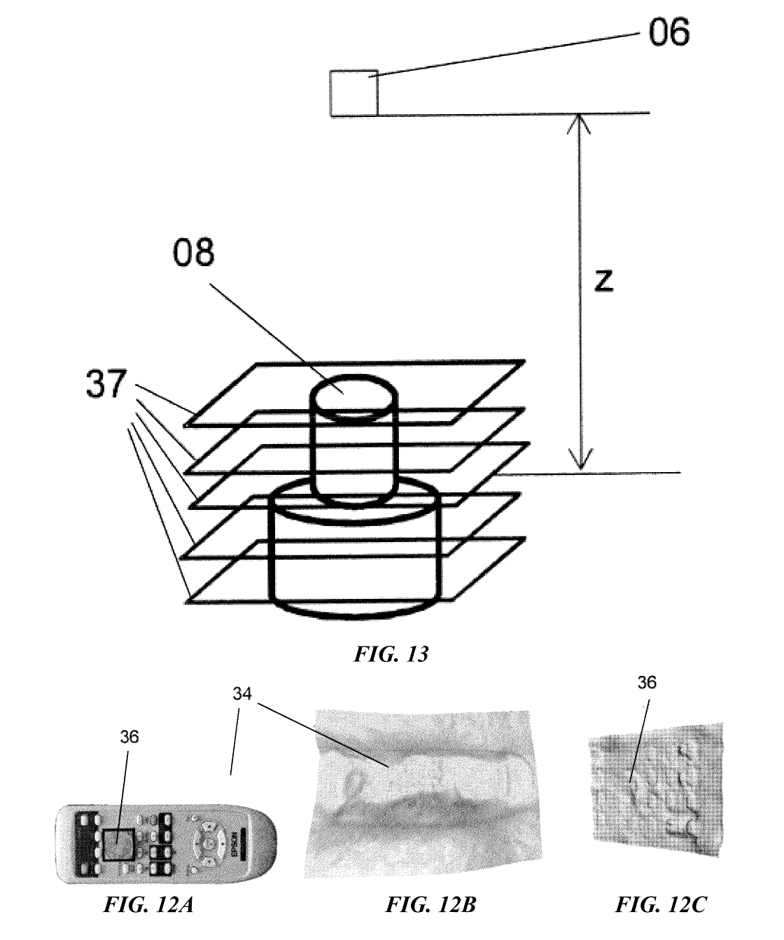

FIG. 12 shows: examples of three-dimensional overview images for the embodiment shown in FIG. 11;

FIG. 13 shows: a basic representation of an alternative for generating a three-dimensional overview image using only a first monitoring sensor;

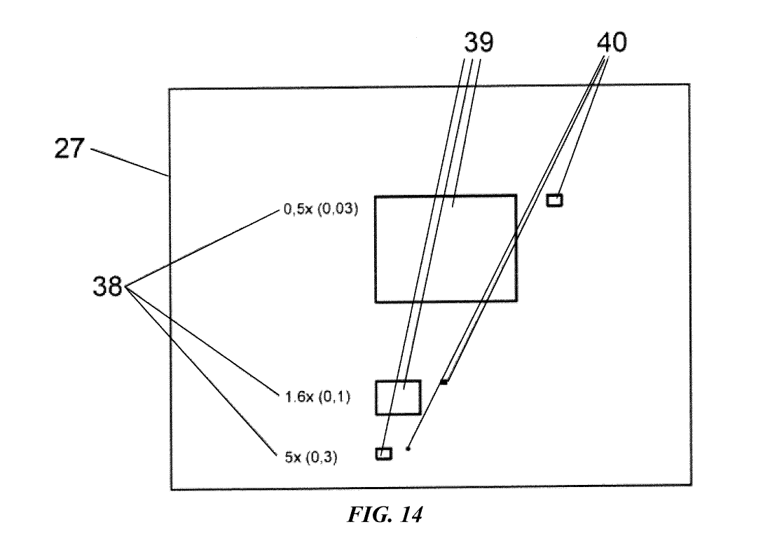

FIG. 14 shows: size ratios of overview image and photomicrographs taken by different lenses, which can be captured in full sensor resolution; and

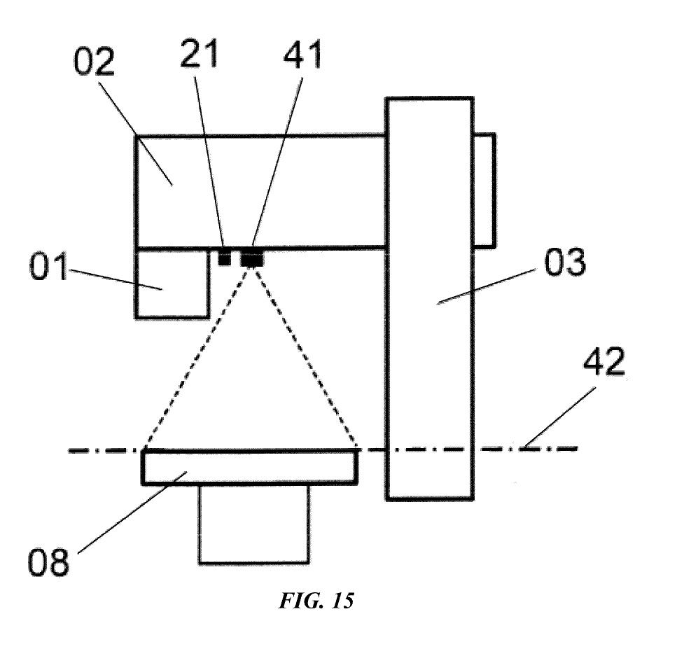

FIG. 15 shows: a basic diagram of a particularly preferred embodiment of a digital microscope.

In FIG. 1, a diagrammatic representation of a digital microscope is shown. The digital microscope comprises a lens 01, a height-adjustable optics unit 02, a preferably swivelable microscope body 03, and a sample table 04. The sample table 04 can be displaced in a known way in a horizontal plane and perpendicularly thereto.

The digital microscope comprises according to the invention a first monitoring sensor designed as an image sensor 06 (preferably a camera sensor), which is arranged on the optics unit 02 and directed onto the sample table 04. On the basis of observation data of the image sensor 06, an overview image is generated in a monitoring unit—not shown—integrated in the optics unit.

A second monitoring sensor, which is formed in this embodiment by two image sensors 07 arranged on the lens 01, can provide, for example, as second observation data, a live reference on the position of the sample table 04. For this purpose, it is possible to observe either a site within a sample 08 or also, for example, the site of an illumination spot which is not represented. Alternatively, just one sensor or more than two sensors can be arranged distributed over the circumference of the lens.

An additional image sensor 09 is used as third monitoring sensor for observing the environment of the sample table 04. The third observation data can be evaluated in this case in order to determine whether a user is moving about with one hand or with both hands in the area of the sample table or of the lens precisely at that time.

In FIG. 2, it is shown that not only image sensors can be used as monitoring sensors. FIG. 2 shows in a diagrammatic representation a digital microscope having the above-mentioned basic components.

Here, a first, a second and a third monitoring sensor are attached as overview cameras 12 at different sites (body 03, optics unit 02) in the digital microscope. In the case of an inverted microscope, an overview camera 13 can naturally also be provided under the sample table 04. Moreover, on the sample table 04, monitoring sensors can be provided as infrared sensors 14, capacitive or resistive sensors 16, 17, whose monitoring data are evaluated in the monitoring unit for monitoring the work process during microscopy work.

In FIGS. 3 to 6, variants for the positioning of the at least first monitoring sensor in the digital microscope are represented. Although here, in each case, an image sensor 06 or a camera sensor is described, the intent is not to limit the invention to this sensor type. The image sensors 06 in these embodiments in each case comprise an additional optical component group 18.

Here, FIG. 3 shows the positioning of the image sensor 06 in the center of the optics unit 02 (Figure a)—view from the side onto the microscope body 03). In Figure b), the image sensor 06 is directed at a slant onto an object plane 19, so that, with regard to a consistently sharp presentation of the object plane, a “Scheimpflug” camera has to be dimensioned. Figure c) shows the image sensor 06 directed perpendicularly onto the object plane 19. An auxiliary illumination unit 21 is provided in each case in the microscope body 03.

In Figure a) of FIG. 4, one can see that two image sensors 6 are arranged at a distance a from one another in the microscope body 03. The distance a can be 120 mm in a preferred embodiment. Here too, the auxiliary illumination unit 21 is arranged in the microscope body 03. According to Figure b), a “Scheimpflug ” camera is dimensioned, while the image sensor 06 according to Figure c) generates a “normal” overview.

FIG. 5 shows the arrangement of the image sensor 06 in the microscope body 03, wherein an observation plane 22 is oriented perpendicularly to the object plane 19.

In FIG. 6, a sensor arrangement in an inverted microscope with a transmitted-light illumination device 23 is shown. In this case, the monitoring sensor designed as image sensor 06 with optical component group 18 is arranged in the sample table 04.

FIG. 7 shows, in a diagrammatic representation, various arrangements of the optical elements of the digital microscope. In Figure b), an optical arrangement is shown, in which the sample 08 has to be displaced for the generation of the overview image in a position POS2 which differs from the lens position POS1. In Figure b), the arrangement of a “Scheimpflug” camera can be seen, while Figure c) shows an arrangement in which no additional optical component group is required. An image deflection device can be integrated in the optics unit and it comprises a plane glass 24 and an additional deflection mirror 25. In this case, the light reflected by the sample is directed via the plane glass 24 to the image taking unit—not shown—and via the image deflection device to the image sensor 06.

FIG. 8 shows examples of overview images of an image sensor as first image sensor within a field of view of 150×150 mm.

FIG. 9 shows examples of overview images with a variation of the depth of field (DoF) and focusing on different height levels. In Figure a), the sample plane 19 is out of focus and the surface of the object 26 in focus, while in Figure b) the sample plane 19 is focused.

In FIG. 10, representations of a possible work process are shown. Starting with the macroscopic overview image 27, one zooms in 80× on the overview image 27 (FIG. 28). At an 80× magnification, one achieves a micro view 29 which consists of joined micro images with a 1 μm resolution. By selecting an area 31 in the micro view 29 and its magnification, the user achieves the microscopic image 32 with a 500× magnification.

FIG. 11 shows a basic diagram of the fundamental procedure for generating a three-dimensional overview image of a sample 08 with only a first monitoring sensor, implemented as an image sensor 06, and with a corresponding optical component group (not shown). In this example, a distance z of 181 mm between image sensor 06 and sample table 04 is set.

A first image with a field of view A of, for example, 150×150 mm is recorded with a first position POS1 of the sample table 04 with the sample 33 located thereon. The first position POS1 of the sample table 04 is shifted, for example, by up to −25 mm (x) from a central position (not shown, x=0).

Subsequently, the taking of a second image occurs, with a setting of a field of view B, which in this case has a size of 202×150 mm, with a second position POS2 of the sample table 04, which is shifted by up to +25 mm (x) from the central position. Subsequently, a reconstruction of the three-dimensional properties of the sample 33 occurs by means of software using photogrammetry and stereogrammetry. The algorithms used for this purpose are known to the person skilled in the art.

In FIG. 12, an example of a three-dimensional overview image generated by means of stereogrammetry is shown. Figure a) shows a two-dimensional image of a remote control 34 with an area 36 represented framed (ROI—region of interest). By means of a stererogrammetry algorithm, an elevation map of the remote control 34 was established (Figure b)). Figure c) shows a zoom on the elevation map. In spite of some uncertainties in the topology, the identification of details with a depth of less than 1 mm (ROI) is possible.

FIG. 13 shows an additional possibility for generating a three-dimensional overview image with a single first monitor sensor designed as image sensor 06. By focus variations (focal lengths z), views in different resolution planes 37 are generated, and from these views a three-dimensional view is generated using known methods.

FIG. 14 represents the microscope images, which can be represented in full resolution, taken by different lenses 38 with different magnifications (5×, 1.6×, 0.5×) and different corresponding numerical apertures (NA=0.03, 0.1, 0.3) relative to the overview image 27.

Here, the respective left microscope image 39 shows the minimum zoom, while the respective right microscopic image 40 shows the surface that can be represented with maximum magnification at full resolution of the first image sensor, in the case of an extent of the overview image, respectively of the surface area of the sample table, that can be represented with the overview sensor, of 130×100 mm.

FIG. 15 shows, in a diagrammatic representation, a particularly preferred arrangement of a digital microscope with a first monitoring sensor designed as camera 41. The camera 41 and the auxiliary illumination device here are arranged on a bottom side of the optics unit 02 next to the lens 01. The microscope body 03 is swivelable in a known manner about a swivel axis 42. The sample table 08 can be aligned with this swivel axis 42 (pivot point of the sample table 08).

### LIST OF REFERENCE NUMERALS

01 Lens
02 Optics unit
03 Body
04 Sample table
05 -
06 Image sensor
07 Image sensor
08 Sample
09 Image sensor
10 -
11 -
12 Overview camera
13 Overview camera
14 Infrared sensor
15 -
16 Capacitive sensor
17 Resistive sensor
18 Optical component group
19 Sample plane
20 -
21 Auxiliary illumination device
22 Observation plane
23 Transmitted-light illumination device
24 Plane glass
25 Deflection mirror
26 Object
27 Macroscopic overview image
28 Image
29 Micro view
30 -
31 Area
32 Microscopic image
33 Sample
34 Remote control
35 -
36 Area (ROI)
37 Resolution plane
38 Lens
39 Microscope image
40 Microscope image
41 Camera
42 Swivel axis
42

1. A digital microscope comprising:
an optics unit (02) and a digital image processing unit, which are arranged on a microscope body (03); and
a microscope image sensor for capturing an image of a sample (08) to be arranged on a sample table (04);
at least one first monitoring sensor for observing the sample (08), the sample table (04), the optics unit (02) or a user; and
a monitoring unit,
wherein, in the monitoring unit, data of the monitoring sensor are evaluated in an automated manner and used for automated control of the digital microscope.

2. A digital microscope according to claim 1, further comprising:
a second monitoring sensor,
wherein the first monitoring sensor and the second monitoring sensor are arranged at spatially different sites on the digital microscope and data of the two monitoring sensors are processed in the monitoring unit into three-dimensional overview information.

3. A digital microscope according to claim 1, further comprising:
a third monitoring sensor,
wherein the first monitoring sensor and the third monitoring sensor are arranged at spatially different sites on the digital microscope, and data of the first and of the third monitoring sensor are processed in the monitoring unit into collision control information.

4. A digital microscope according to claim 1, wherein the first monitoring sensor is an image sensor (06, 07, 09) or a camera (41).

5. A digital microscope according to claim 2, wherein the second monitoring sensor is an image sensor (06, 07, 09).

6. A digital microscope according to claim 1, further comprising an auxiliary illumination device (21).

7. A method for optimizing a work process in a digital microscope with an optics unit (02) and with a first monitoring sensor, comprising the following steps:
acquiring first observation data from the first monitoring sensor of a sample table (04), of the optics unit (02) or of a user, at the time of observation of a sample (08) arranged on the sample table (04);
automatically analyzing and evaluating the first observation data of the first monitoring sensor and generating control data;
using the control data to control the work process of the digital microscope.

8. A method according to claim 7, further comprising:
acquiring second observation data from a second monitoring sensor, which is arranged with spatial offset relative to the first monitoring sensor in the digital microscope;
generating a three-dimensional overview image or an elevation map of the sample from the first and second observation data,

9. A method according to claim 8, further comprising at least one of:
using the first and second observation data for an approximate positioning of the sample table (04); and
using the first and second observation data for an automated adjustment of a focus of a lens (01).

10. A method according to claim 7, wherein an illumination of the sample table (04) occurs during the acquisition of illumination data.
